(19) United States
(12) Patent Application Publication
(10) Pub. No.: US 2014/0223528 A1
(43) Pub. Date: Aug. 7, 2014

(54) CERTIFICATE INSTALLATION AND DELIVERY PROCESS, FOUR FACTOR AUTHENTICATION, AND APPLICATIONS UTILIZING SAME

(71) Applicant: Open Access Technology International, Inc., Minneapolis, MN (US)

(72) Inventors: Ilya Slutsker, Plymouth, MN (US); Sasan Mokhtari, Eden Prairie, MN (US); Eric Mickols, Minneapolis, MN (US); Vuthy Phan, Burnsville, MN (US); Jaspreet Singh, Rogers, MN (US)

(73) Assignee: Open Access Technology International, Inc., Minneapolis, MN (US)

(21) Appl. No.: 14/054,611

(22) Filed: Oct. 15, 2013

Related U.S. Application Data
(60) Provisional application No. 61/713,881, filed on Oct. 15, 2012.

(51) Int. Cl. H04L 29/06

(52) U.S. Cl. CPC H04L 63/08
USPC 726/6

(57) ABSTRACT

A process/method is provided, which facilitates the secure, streamlined and authenticated installation of an end user's personally associated electronic identification, such as but not necessarily limited to Public Key Infrastructure digital certificates, a biometric authentication system, a location-based authentication system, a token-based system, and any ancillary software necessary for facilitating electronic security approaches associated with these technologies onto Mobile Devices with minimal Mobile Device end user interaction and without need for sending the personally associated electronic identification across potentially insecure communication protocols. The invention utilizes proprietary communication between Mobile Device software applications, personally associated electronic identification authority servers, and web-based application servers to verify Mobile Device identity and to authenticate end user credential factors and requests for end user credential factors with minimal end user interaction. The disclosed process/method may provide a system for verifying identity by authenticating Mobile Device end users via the submission of multiple credential factors.

### CROSS-REFERENCE TO RELATED APPLICATIONS

This application claims priority to provisional patent application No. 61/713881 filed Oct. 15, 2012, the entire contents of which are hereby incorporated by reference.

### STATEMENT REGARDING FEDERALLY SPONSORED RESEARCH

Not Applicable

### FIELD OF THE INVENTION

The present disclosure relates to a method, a system, and a process for securely associating a unique end user with an electric device that communicates with other devices or networks, such as but not necessarily limited to, computer tablets, e-readers, smart phones, smart televisions, smart appliances, in-home or on-premise devices, cable boxes, thermostats, mechanical system controllers, communication system devices, and other such devices as such words are commonly used (hereinafter referred to as “Mobile Devices” or a “Mobile Device”), and additionally securely installing the end user's personally associated electronic identification, such as but not necessarily limited to a digital certificate capable of facilitating authentication security approaches such as a Public Key Infrastructure (PKI) digital certificate, a token-based system for synchronized random number generation authentication, a biometric authentication system, a location-based authentication system, a token-based system, and any ancillary software necessary for facilitating electronic security approaches associated with these technologies (hereinafter referred to as “Personal Authentication Credential Factor” in the singular but specifically incorporating the plural) onto the Mobile Devices. More particularly, the disclosure relates to a novel implementation of a method, a system, and a process for securely associating, communicating, distributing, and otherwise installing an end user's Personal Authentication Credential Factor without the need for manual transmittal of the Personal Authentication Credential Factor over communication protocols and with minimal Mobile Device end user input and interaction.

### BACKGROUND OF THE INVENTION

The invention is comprised of a process for both associating the Personal Authentication Credential Factor with Mobile Devices and installing the Personal Authentication Credential Factor onto such Mobile Devices. The process under current use in the art involves an entity tasked with maintaining and facilitating an organization's cyber security standards, such as a security officer or other such named role or function, supplying the Mobile Device user with a copy of the user's Personal Authentication Credential Factor for installation onto the Mobile Device, or the same such security officer or other such named role or function acquiring a Mobile Device user's Mobile Device for a period of time in which to personally complete such installation. Under current practice, supplying a Personal Authentication Credential Factor to a Mobile Device user requires the authentication and encryption enabling software file be sent across a communication protocol, thereby subjecting the file to potential interception or corruption. Moreover, a Mobile Device user acquiring a Personal Authentication Credential Factor by this means is then required to undertake the process of installing and correctly associating the Personal Authentication Credential Factor onto a non-authenticated Mobile Device. Alternatively, if the Mobile Device is surrendered to a security officer or other such named role or function for installation of the Authentication Credential, in addition to the impacts on security officer or other such named role or function resources, the Mobile Device user experiences down time as well as logistical issues related to relinquishing control of their Mobile Device for a period of time.

### BRIEF SUMMARY OF THE INVENTION

In order to solve the problems discussed above, applicants have invented Mobile Device software applications which can securely message with a requester server. The Mobile Device software applications are linked to and communicate with web-based software applications hosted on web-based application servers. Users of the web-based software application will have already created or been assigned one or more factors used to verify and authenticate the user's identity. These factors are comprised of a user name, password and Personal Authentication Credential Factor, among other information. The Mobile Device software applications communicate with the web-based software applications via API through a web-based software application request server as facilitated through mobile communication networks and other potentially related computer networks. The Mobile Device software applications are also able to communicate via API with the requester server(s) of the system that facilitates use of, issues, manages and/or establishes trust of the Personal Authentication Credential Factor (“Authority”). Specific functions of the Authority depend upon the type of Authority and Personal Authentication Credential Factor utilized. In the case of PKI, as an illustrative and non-limiting example only, the Authority is the certificate authority that issued the applicable digital certificate. The Mobile Device software applications are installed onto a Mobile Device with components including but not limited to, a processor (typically but not necessarily a microprocessor); a communications device which allows the Mobile Device to communicate with the requester servers via a data network (including but not limited to the internet); a memory, the memory containing the Mobile Device software application; the memory also containing a Mobile Device unique identification referent, such as a unique number, digits, or combination thereof, (hereinafter referred to a Mobile Device ID), said Mobile Device ID serving as an additional factor to uniquely identify and authenticate the Mobile Device and the user thereof

The Mobile Device software applications have varied operational purposes, but all are capable of being installed onto a Mobile Device through many various means known in the art. The Mobile Device software applications are programmed with the same encoding and hashing routines that are used by the system that issues the Personal Authentication Credential Factor such that certain values hashed or encoded by said system can be restored to the original certain value by the Mobile Device software applications. The Mobile Device software application queries the Mobile Device and prompts the end user to input valid credential factors to communicate with a requester server(s) for validation and authentication. The Mobile Device software applications present appropriate messages to the Mobile Device end user in response to receiving certain communication from a requester server(s).

The invention may take the form of a system for the secure distribution of Personal Authentication Credential Factor, such as but not necessarily limited to digital certificates, for Mobile Devices, configured to:
provide authentication of a Mobile Device through verification of the end user's Personal Authentication Credential Factor,
validate the presence of a Personal Authentication Credential Factor on a Mobile Device,
send a Personal Authentication Credential Factor to a Mobile Device associated with an authenticated end user presenting a valid request for a Personal Authentication Credential Factor,
store the Personal Authentication Credential Factor in the Mobile Device's internal memory,
Authenticate the end user upon login from the Mobile Device to an application based on the following four factors: username, password, Personal Authentication Credential Factor, and Mobile Device ID.

The invention may also include a method for establishing the authenticity of a Mobile Device end user's attempt to log in and utilize Mobile Device software applications from a Mobile Device by:
authenticating the end user based on a username factor,
authenticating the end user based on a password factor,
authenticating the end user based on a Personal Authentication Credential Factor, and
authenticating the end user based on a Mobile Device ID factor.

The details of one or more aspects of the disclosure are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating the request to initiate access to a Mobile Device software application that requires a Personal Authentication Credential Factor.

FIG. 2 is a block diagram illustrating an embodiment of the Personal Authentication Credential Factor Preparation Process, wherein the Personal Authentication Credential Factor is a PKI digital certificate.

FIG. 3 is a block diagram illustrating the Personal Authentication Credential Factor installation process.

FIG. 4 is a block diagram illustrating the Mobile Device User Authentication Process.

### DETAILED DESCRIPTION OF THE INVENTION

While this invention may be embodied in many forms, there are specific embodiments of the invention described in detail herein. This description is an exemplification of the principles of the invention and is not intended to limit the invention to the particular embodiments illustrated.

For the purposes of this disclosure, like reference numerals in the figures shall refer to like features unless otherwise indicated.

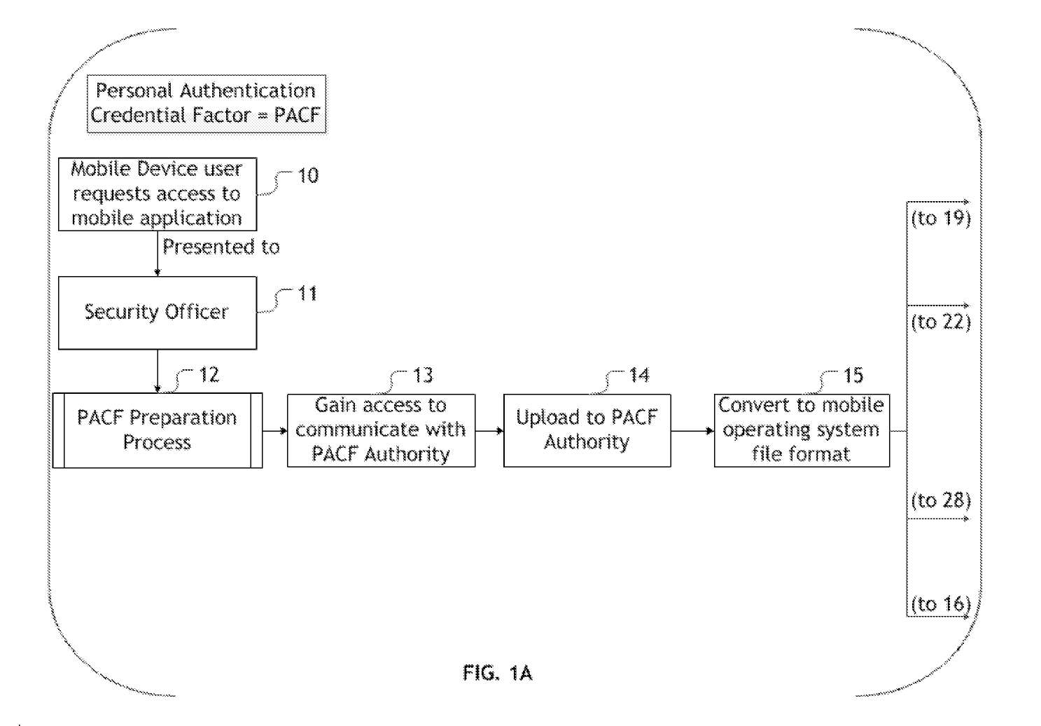

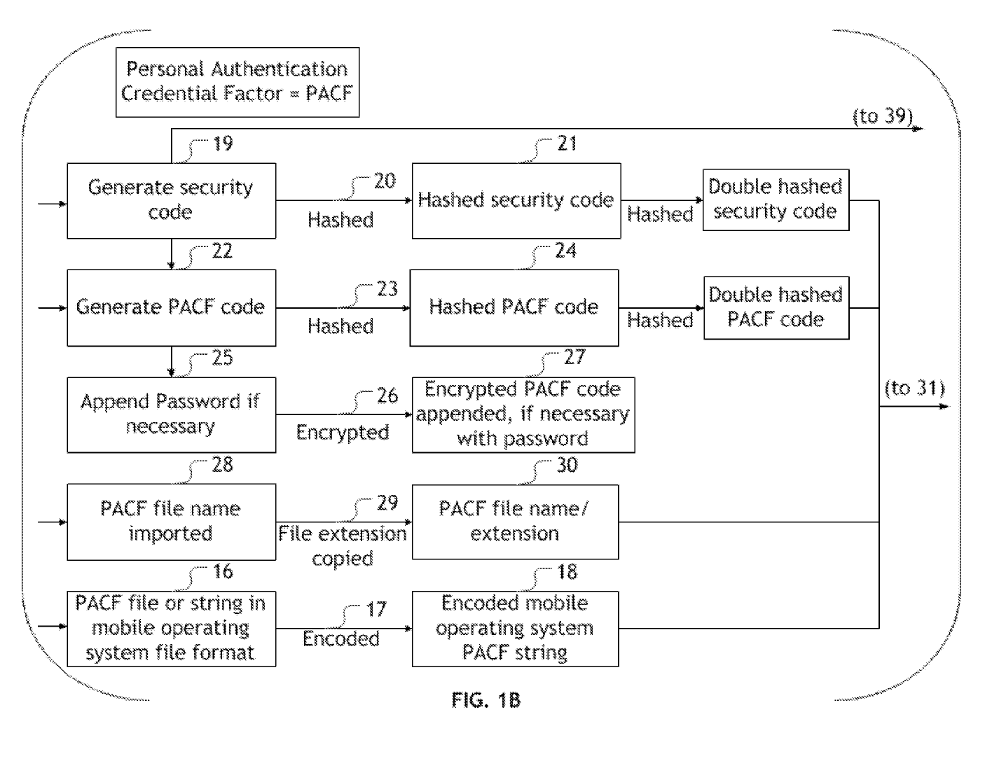

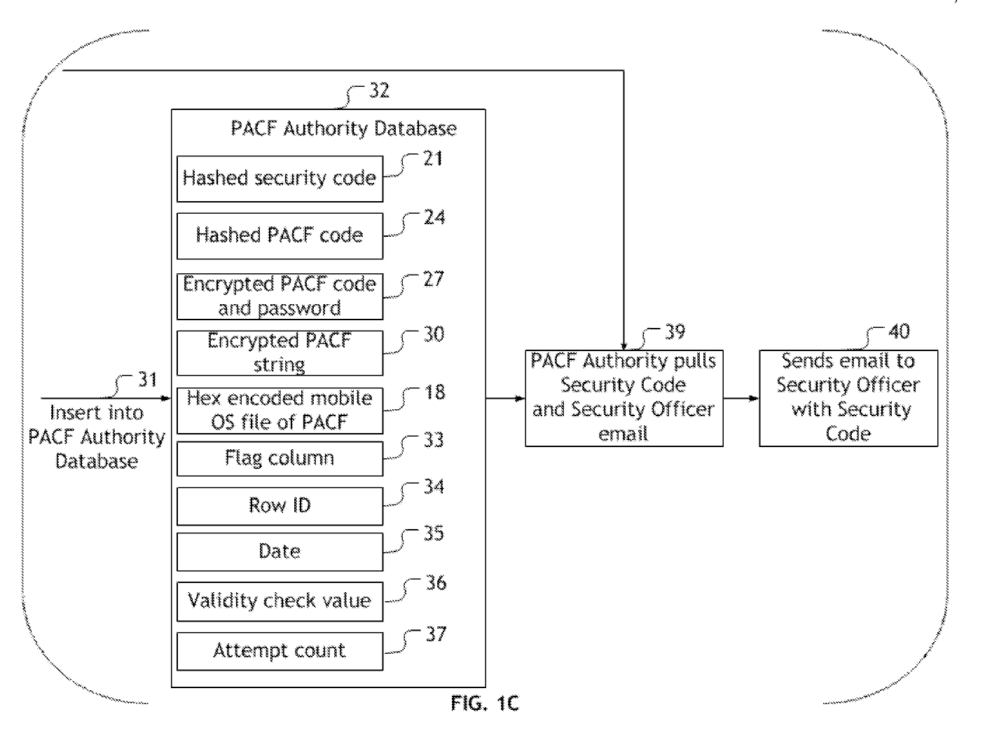

The current invention solves the problem of requiring sensitive, confidential, and potentially exploitable information concerning a Personal Authentication Credential Factor, such as but not necessarily limited to a digital certificate, be sent over potentially insecure communication protocols, for installation onto a Mobile Device for use in conjunction with other authenticating factors, such as but not limited to username, password and Mobile Device ID, for user authentication purposes when logging into Mobile Device software applications. The invention also presents an improvement on usability, requiring very little Mobile Device end user interaction and subject matter expertise in order to install a Personal Authentication Credential Factor onto a Mobile Device in a manner in which such Personal Authentication Credential Factor is not retrievable for uses other than that which is intended. Referring to FIG. 1, the process begins with a Mobile Device end user's request 10 for access to use a Mobile Device software application. The request 10 is presented to an authorized security entity or system whose role or function includes being charged with the maintenance, authentication of users, and distribution of Personal Authentication Credential Factors for Mobile Device users (referred to herein as “Security Officer”) 11 in order to obtain Personal Authentication Credential Factor. The Security Officer 11 can be any individual, software or similar entity or system capable of sending communication to and receiving communication from Personal Authentication Credential Factor Authority. In one embodiment, the Security Officer 11 will have a user account created with a Personal Authentication Credential Factor Authority for the purposes of accessing a web portal in order to facilitate the functions of a Security Officer 11. Such user account may comprise of various contact information, including but not limited to, name, email address and password. The Security Officer 11 then initiates a Personal Authentication Credential Factor preparation process 12 in order to obtain the Mobile Device end user's pre-existing, assigned Personal Authentication Credential Factor. If the Mobile Device end user does not already have an allocated Personal Authentication Credential Factor, the Security Officer 11 will undertake the requisite steps for validation and distribution of a Personal Authentication Credential Factor as determined by the Personal Authentication Credential Factor Authority along with any other internal policies.

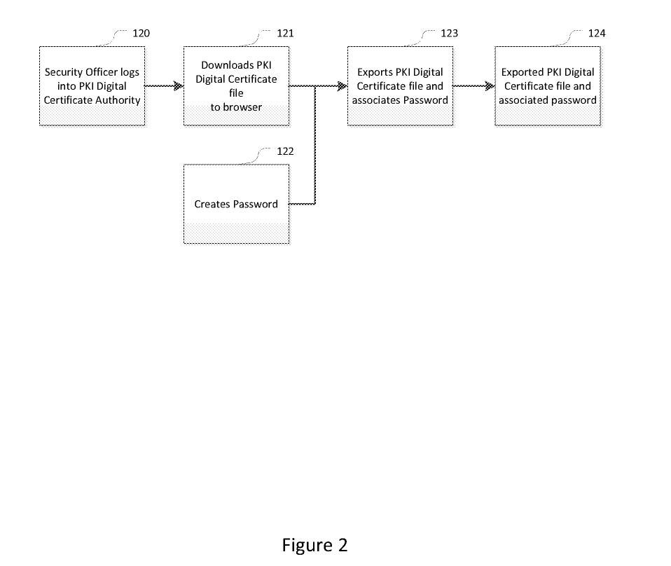

Referring now to FIG. 2, in one particular embodiment of the Personal Authentication Credential Factor preparation process 12 wherein the Personal Authentication Credential Factor is a PKI digital certificate, the Security Officer 11 will gain access 120 to the Personal Authentication Credential Factor Authority in the means necessary to download the Mobile Device end user's Personal Authentication Credential Factor file. In one embodiment, the Security Officer 11 may log into a web portal of the Personal Authentication Credential Factor Authority. The Security Officer 11 will download the PKI digital certificate file, to their internet browser or other such communication network 121. The Security Officer 11 creates a password 122. Then the Security Officer 11 exports the PKI digital certificate file from the browser 123. As part of the exportation of the PKI digital certificate from the internet browser 123, the Security Officer 11 must associate the password 122 to the PKI digital certificate file resulting in a now exported PKI digital certificate, which is a particular embodiment of a Personal Authentication Credential Factor, 124 stored in computer memory. The Security Officer's 11 acquisition of the Mobile Device end user's Personal Authentication Credential Factor file 124 completes this particular embodiment of the Personal Authentication Credential Factor preparation process 12, wherein the Personal Authentication Credential Factor is a PKI digital certificate.

Referring back to FIG. 1, the Security Officer 11 will gain access to the Personal Authentication Credential Factor Authority and upload 13 the Personal Authentication Credential Factor file 124 to the Authority. In one embodiment of the invention, the Security Officer 11 may gain access to the Personal Authentication Credential Factor Authority 13 by logging in to Personal Authentication Credential Factor Authority's secure web portal in order to upload 14 and convert 15 the Personal Authentication Credential Factor file or string into a mobile operating system Personal Authentication Credential Factor file or string format, such as but not necessarily limited to PKI digital certificate file formats required for the iOS or Android mobile operating systems. Upon uploading the Personal Authentication Credential Factor file 124, the Security Officer 11 communicates instructions for the Personal Authentication Credential Factor Authority 13 to convert 15 the Personal Authentication Credential Factor file or string into a mobile operating system Personal Authentication Credential Factor file or string format.

In response to the receipt of instructions to convert 15 the Personal Authentication Credential Factor file or string into a mobile operating system Personal Authentication Credential Factor file or string format, the Authority processes several actions nearly simultaneously and in any order, unless specifically noted otherwise.

The Personal Authentication Credential Factor file or string is converted 16 into mobile operating system file or string format. In one particular embodiment, the conversion may be performed by the Authority 13 using an application known in the art. The resulting mobile operating system Personal Authentication Credential Factor file or string from the conversion 16 is then encoded 17, resulting in an encoded Personal Authentication Credential Factor in mobile operating system file or string format 18. In one particular embodiment, the mobile operating system Personal Authentication Credential Factor file or string is hex encoded.

A security code 19 is generated, comprised of a various length character string generated by a random number generator. The security code 19 is then hashed 20 one or multiple times, resulting in a hash security code 21. The hash 20 performed on the security code 19 can comprise many various techniques known in the art so long as the hash 20 performed is capable of repetition, such that the hash 20 of the security code 19 will always result in the same hash security code 21 value.

A Personal Authentication Credential Factor code 22 may be generated, comprised of a various length character string generated by a random number generator. In one particular embodiment, following the generation of the Personal Authentication Credential Factor code 22 the Personal Authentication Credential Factor code 22 may then be copied and appended by the password 122 created during the Personal Authentication Credential Factor preparation process 12. The resulting Personal Authentication Credential Factor code which may be appended 25 is then encrypted 26 by the Authority 13 resulting in an encrypted Personal Authentication Credential Factor code which may be appended with a password 27.

The Personal Authentication Credential Factor code 22 may then be hashed 23 one or multiple times, resulting in a hash Personal Authentication Credential Factor code 24. The hash 23 performed on the Personal Authentication Credential Factor code 22 can comprise many various techniques known in the art so long as the hash 23 performed is capable of repetition, such that the hash 23 of the Personal Authentication Credential Factor code 22 will always result in the same hash Personal Authentication Credential Factor code 24 value.

The file name of the Personal Authentication Credential Factor string 124 is also imported 28. The file extension is determined and copied 29. This results in the Personal Authentication Credential Factor file name and extension 30.

The hashed security code 21, hashed Personal Authentication Credential Factor code 24, encrypted Personal Authentication Credential Factor code which may be appended with a password 27, Personal Authentication Credential Factor file name and extension 30, and encoded mobile operating system Personal Authentication Credential Factor file string 18 are then inserted 31 by the Authority to an Authority database 32 along with other elements, including but not limited to, a flag column 33, row id column 34, date column 35, validity check value 36, and attempt counter column 37. The Authority 13 then pulls the associated security code 19 and the Security Officer's 11 email address 39 in order to send an email 40 comprised of the security code 19 associated with the Mobile Device end user's Personal Authentication Credential Factor 124 entry to the email address associated with the Security Officer's 11 Personal Authentication Credential Factor Authority user account. The Security Officer 11 now has an email 40 with the security code 19 associated with the Mobile Device end user's Personal Authentication Credential Factor file or string 124.

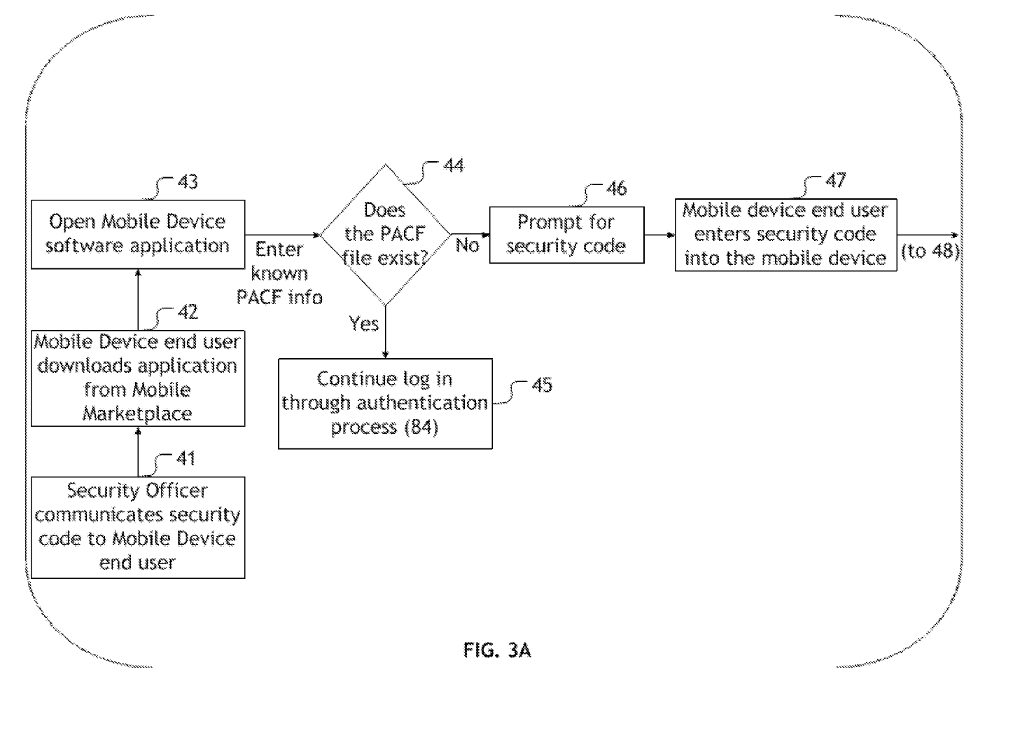

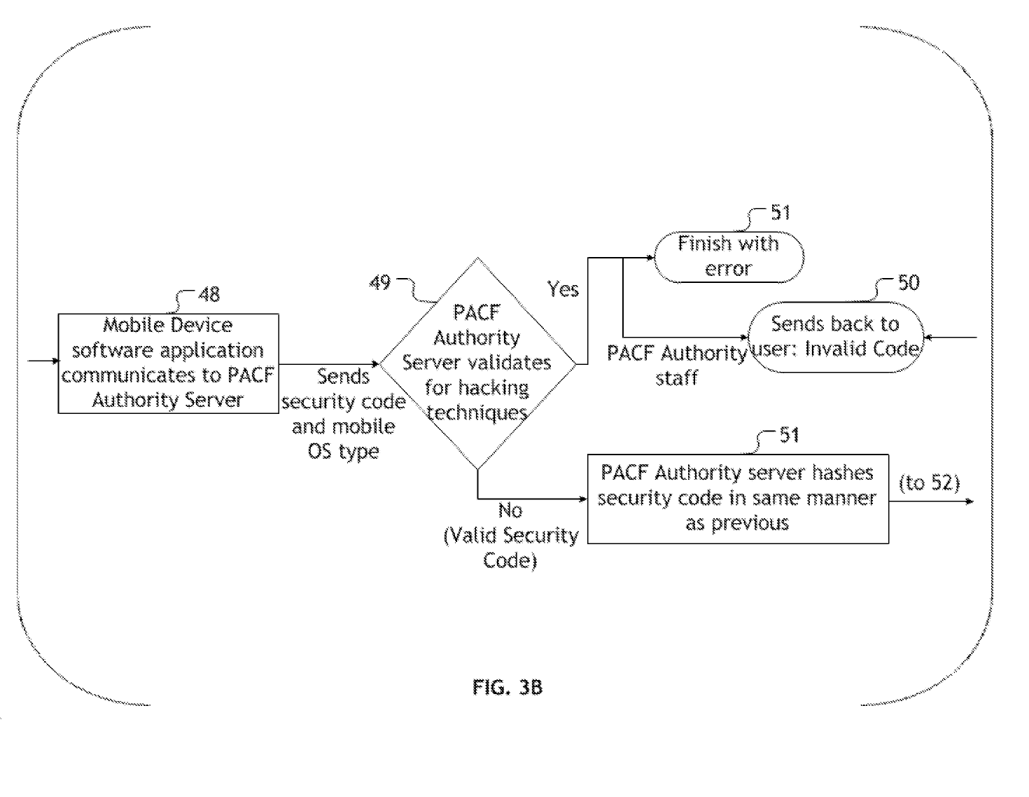

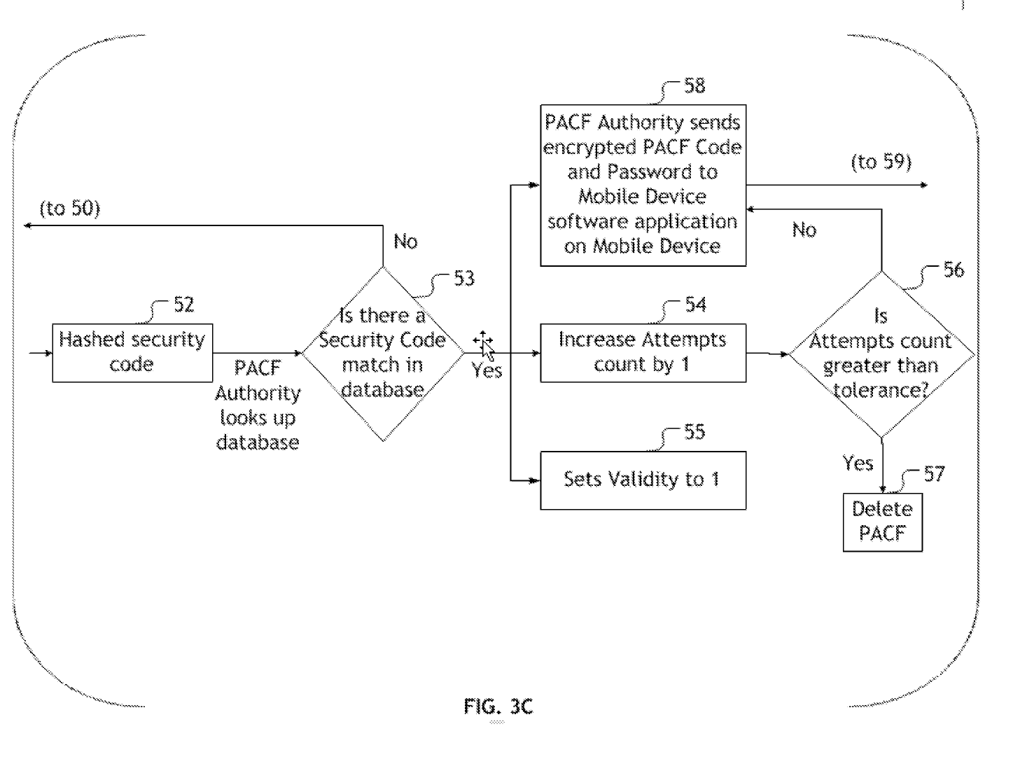

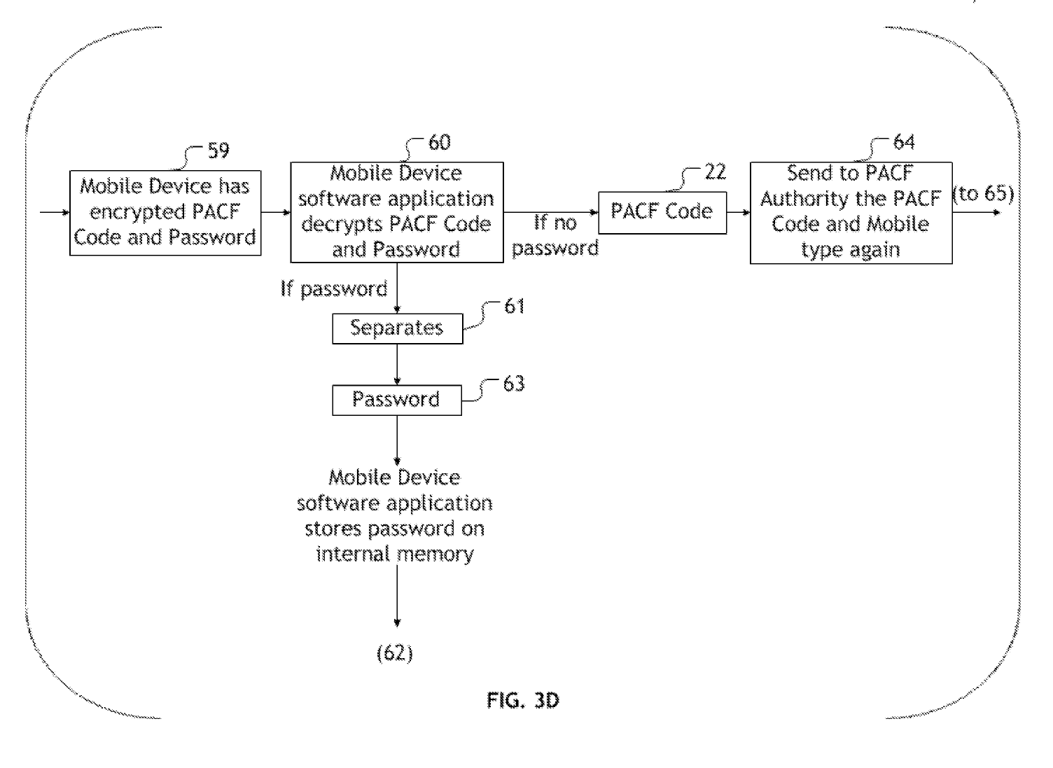

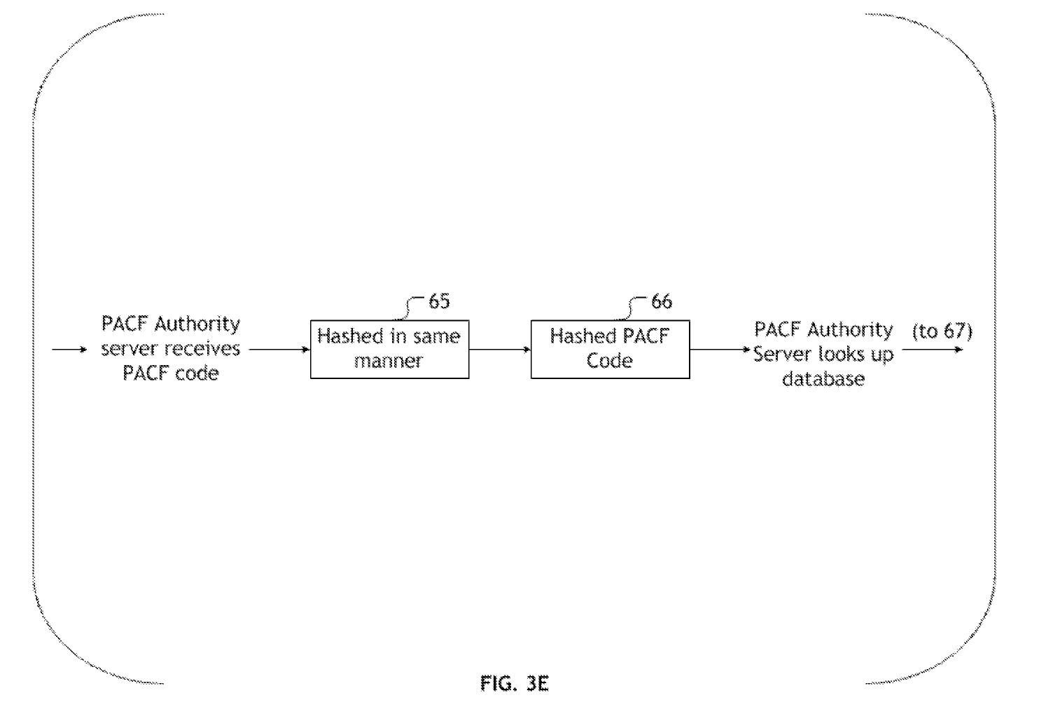

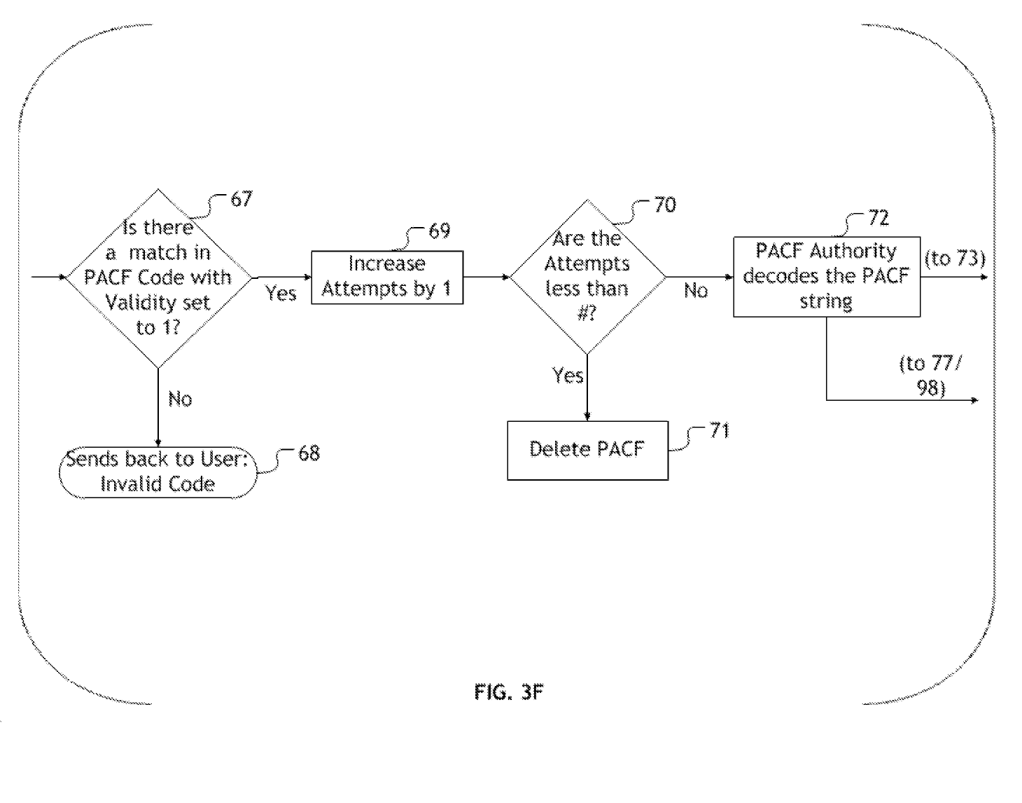

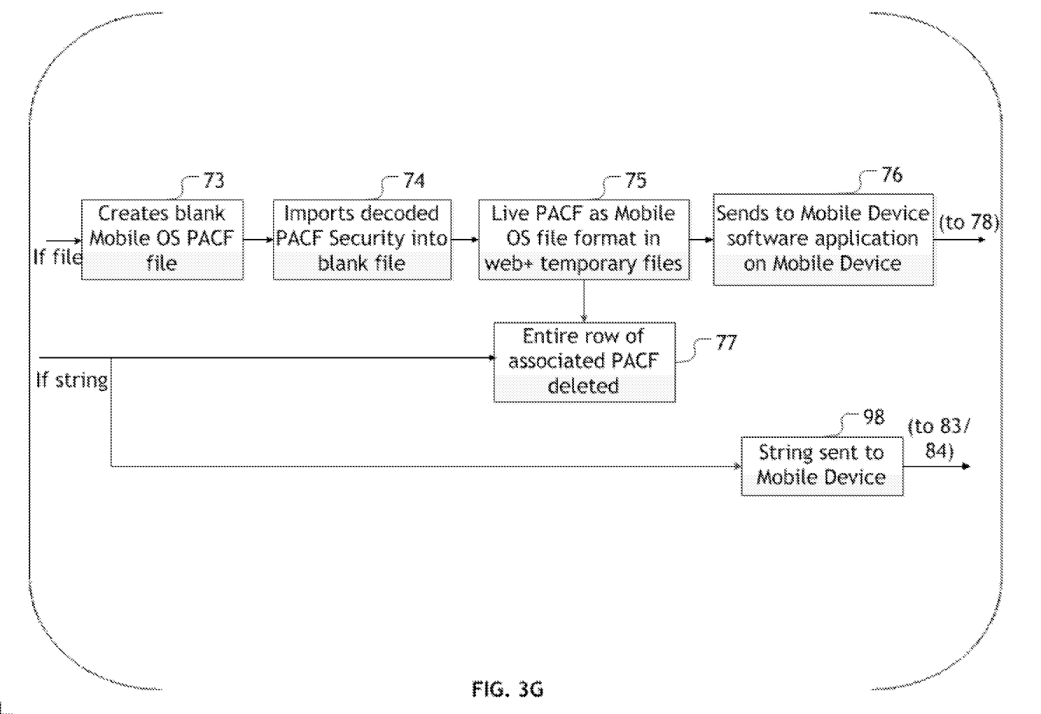

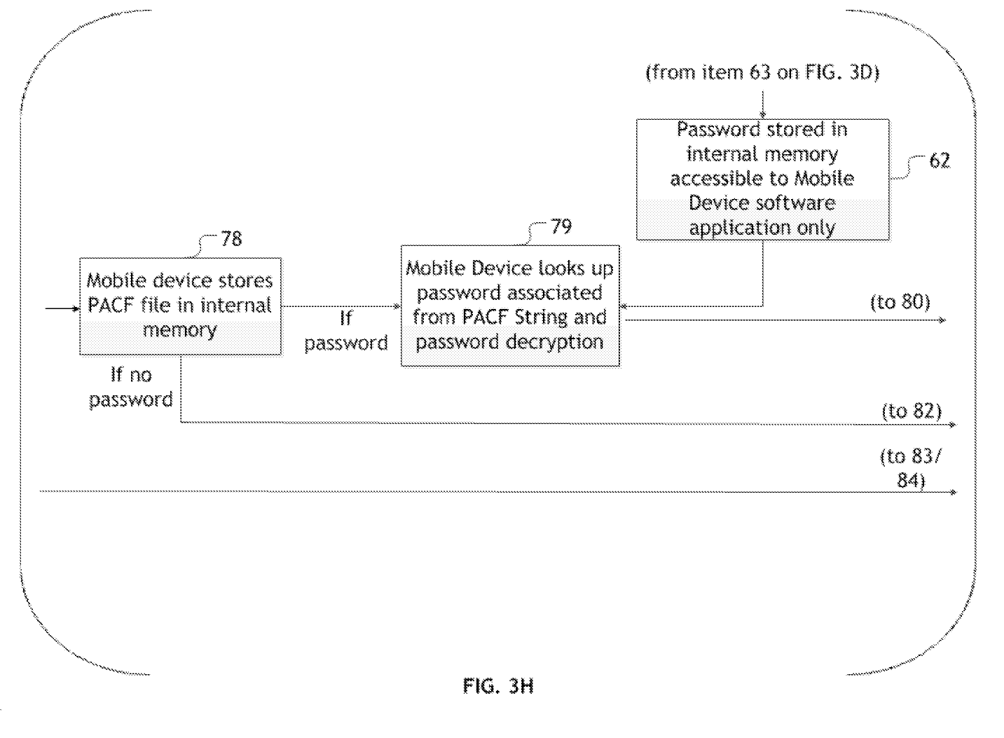

Referring now to FIG. 3, the Security Officer 11 will communicate 41 the security code 19 to the Mobile Device end user as authenticated by the Security Officer 11 according to any requirements of the Personal Authentication Credential Factor Authority or other proprietary processes. The Mobile Device end user downloads and installs 42 the Mobile Device software application through various means, including but not limited to, interacting with a mobile marketplace or app store. The Mobile Device end user opens 43 the Mobile Device software application. Upon start up 43, the Mobile Device end user enters and submits known Personal Authentication Credential Factors, triggering the Mobile Device software application to search 44 for an installed Personal Authentication Credential Factor file or string 124. If the Mobile Device software application finds a Personal Authentication Credential Factor installed, the Mobile Device software application proceeds to log into application 45 and begin the authentication process 84. If such application finds no Personal Authentication Credential Factor installed, then Mobile Device application prompts 46 for the security code 19.

The Mobile Device end user enters 47 the security code 19 into the Mobile Device application. Upon submission, the Mobile Device application communicates 48 with the Authority, sending the submitted security code 19 and the Mobile Device operating system type.

In one particular embodiment, the Authority 13 may validate 49 the submitted information from the Mobile Device software application for known hacking techniques. If the Authority 13 recognizes known hacking techniques within the contents of the information submitted by the Mobile Device software application, the Authority 13 may respond 50 with appropriate invalid messaging and may also notify Authority staff and finish with an error 51. If the Authority 13 does not recognize any known hacking techniques within the contents of the information submitted by the Mobile Device software application, the Authority 13 then hashes 51 the security code 19 in the same manner as security codes 19 were previously hashed to result in a hashed security code 52 as submitted by the Mobile Device software application.

The Authority 13 validates 53 against the Authority database 32 for a matching hashed security code 21. If no match can be found in the Authority database 32, the Authority 13 responds 50 to the Mobile Device software application with an appropriate error message. If a matching hashed security code 21 is found, the Authority 13 1) updates 55 the Authority database 13 record to set the validity check value 36 to a status indicating “valid,” 2) increases 54 the associated attempt count 37 by 1. The Authority 13 then performs a validation 56 on whether the attempt count 37 is greater than a preset tolerance value. If the Authority 13 determines the attempt count 37 is greater than the preset tolerance value, the record associated with the Personal Authentication Credential Factor file or string 124 is deleted 57 from the Authority database 13. If the Authority 13 determines the attempt count 37 is less than or equal to the preset tolerance value, the validation passes and the record remains.

The Authority 13 then sends 58 the Mobile Device software application the encrypted Personal Authentication Credential Factor code which may be appended with a password 27. The Mobile Device receives 59 the encrypted Personal Authentication Credential Factor code which may be appended with a password 27 and saves to internal, temporary memory. The Mobile Device software application decrypts 60 the encrypted Personal Authentication Credential Factor code which may be appended with a password 27.

In one particular embodiment wherein the encrypted Personal Authentication Credential Factor code which may be appended with a password 27 is appended with a password, the Mobile Device software application then separates 61 the Personal Authentication Credential Factor code 22 from the password 63. The password 63 is saved 62 to the Mobile Device's internal memory. The Mobile Device software application communicates 64 the Personal Authentication Credential Factor code 22 back to the Authority 13. In a particular embodiment wherein encrypted Personal Authentication Credential Factor code which may be appended with a password 27 is not appended with a password, the Mobile Device software application communicates 64 the Personal Authentication Credential Factor code 22 back to the Authority 13.

In one particular embodiment, the Mobile Device software application may also communicate 64 the Mobile Device type.

The Authority 13 receives the communication 64 comprised of the Personal Authentication Credential Factor code 22 and hashes 65 it in the same manner as such Personal Authentication Credential Factor codes 22 were previously hashed 23 to result in a hashed code 66 as submitted by the Mobile Device software application. The Authority 13 then queries the hashed security code 66 against the Authority's database 32 to search 67 for a match. If the Authority 13 is unable to find a matching hashed code 24 in the Authority's database 32, the Authority 13 responds 68 to the Mobile Device software application with an appropriate error message. If a matching hashed code 24 is found, the Authority increases 69 the associated attempt count 37 by 1. The Authority 13 then performs a validation 70 on whether the attempt count 37 is greater than a preset tolerance value. If the Authority 13 determines the attempt count 37 is greater than the preset tolerance value, the record associated with the Personal Authentication Credential Factor file 124 is deleted 71 from the Authority's database 32. If the Authority 13 determines the attempt count 37 is less than or equal to the preset tolerance value, the validation passes and the record remains.

Upon passing the validation 70, the Authority 13 decodes 72 the Personal Authentication Credential Factor file or string 18

In one particular embodiment wherein that Personal Authentication Credential Factor is a string, the Personal Authentication Credential Factor string is sent 99 to the Mobile Device. The Authority 13 removes 77 the row associated with the Personal Authentication Credential Factor from the Authority's database 32. The Personal Authentication Credential Factor string is made available to the for Mobile Device user as a Personal Authentication Credential Factor 83 and an end user Authentication process 84 may be initialized when the Mobile Device end user attempts to start up and login to a Mobile Device software application that requires connection to databases stored on a web application server.

In another particular embodiment wherein the Personal Authentication Credential Factor is a file, the Authority 13 will then create a blank mobile operating system Personal Authentication Credential Factor file 73 and store in temporary memory. The Personal Authentication Credential Factor file string is then inserted into the blank mobile operating system Personal Authentication Credential Factor file 74 to create a live mobile operating system Personal Authentication Credential Factor file 75.

The Authority 13 then sends 76 the live mobile operating system Personal Authentication Credential Factor file 75 to the Mobile Device and removes 77 the row associated with the Personal Authentication Credential Factor from the Authority's database.

Upon receipt of the live mobile operating system Personal Authentication Credential Factor file 75, the Mobile Device software application stores 78 the live mobile operating system Personal Authentication Credential Factor file 75 in internal memory of the Mobile Device.

In one particular embodiment wherein the encrypted Personal Authentication Credential Factor code which may be appended with a password 27 is appended with a password, the Mobile Device software application then retrieves 79 the password 63 as previously stored from the Personal Authentication Credential Factor code which may be appended with a password 25. The Mobile Device software application validates 80 to ensure the password 63 matches the password 122 associated with the live mobile operating system Personal Authentication Credential Factor file 75. If the password 63 does not match the password 122 associated with the live mobile operating system Personal Authentication Credential Factor file 75, then the Mobile Device software application responds 81 to the Mobile Device end user with an appropriate prompt. If the password 63 matches the password 122 associated with the live mobile operating system Personal Authentication Credential Factor file 75, then the Mobile Device software application installs and saves 82 the live mobile operating system Personal Authentication Credential Factor file 75 into the internal memory within the Mobile Device where it is accessible only to the specific Mobile Device software application. In one particular embodiment, the live mobile operating system Personal Authentication Credential file 75 is installed and saved 82 by the Mobile Device software application in the application pool folder of the Mobile Device.

In one particular embodiment wherein the encrypted Personal Authentication Credential Factor code which may be appended with a password 27 is appended with a password, the Mobile Device software application then the Mobile Device software application installs and saves 82 the live mobile operating system Personal Authentication Credential Factor file 75 into the internal memory within the Mobile Device where it is accessible only to the specific Mobile Device software application. In one particular embodiment, the live mobile operating system Personal Authentication Credential file 75 is installed and saved 82 by the Mobile Device software application in the application pool folder of the Mobile Device.

The live mobile operating system Personal Authentication Credential Factor file 75 is now available for the Mobile Device end user as a credential factor 83 to log into the Mobile Device software application.

In one particular embodiment, and after the live mobile operating system Personal Authentication Credential Factor personally associated identification information, such as a digital certificate, file 75 is installed, an end user Authentication process 84 may be initialized when the Mobile Device end user attempts to start up and login to a Mobile Device software application that requires connection to databases stored on a web application server.

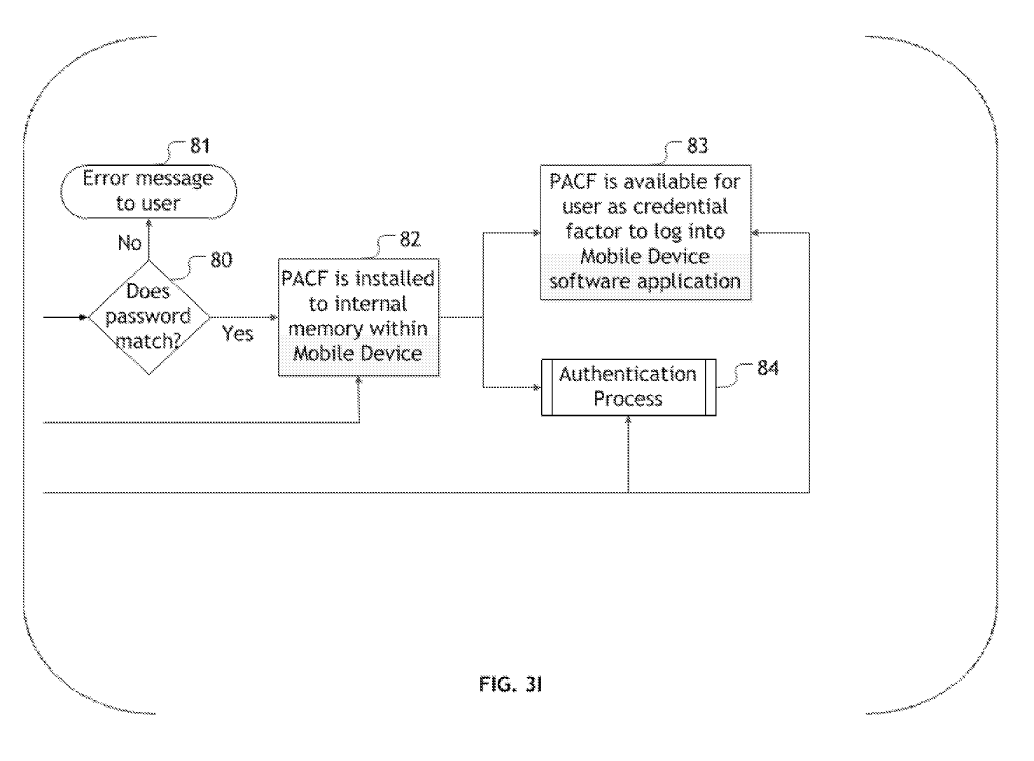

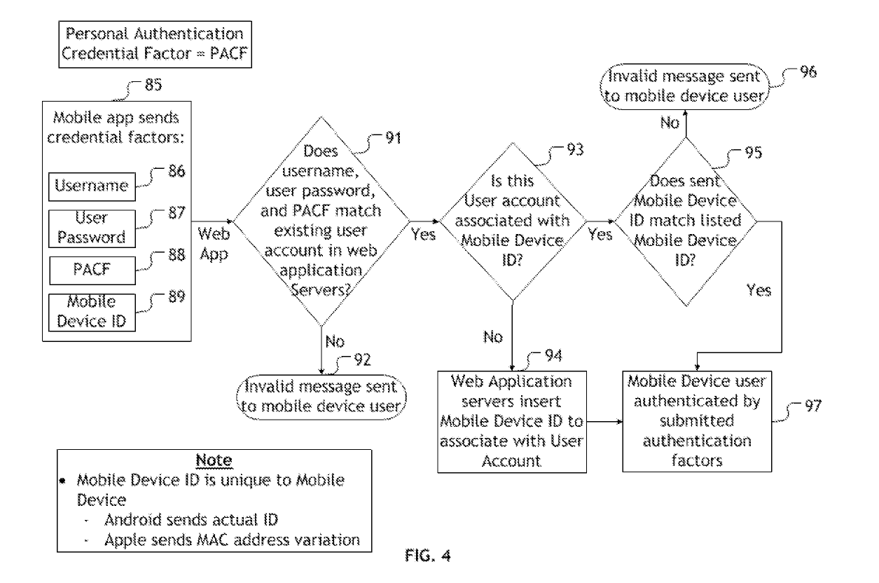

Referring now to FIG. 4, the Mobile Device end user authentication process 84 begins after the installation of the live mobile operating system Personal Authentication Credential Factor file 75, when the Mobile Device software application sends credential factors 85, including but not limited to, the Mobile Device end user's username 86 and user password 87 associated with the Mobile Device end user's application user account, the Personal Authentication Credential Factor 88, and Mobile Device ID 89 to the web application server 90. In one particular embodiment wherein the Personal Authentication Credential Factor is a PKI digital certificate, the Personal Authentication Credential Factor 88 may comprise a digital certificate public key or other security element and digital certificate subject string. The web application server 90 then validates 91 whether the credentials factors sent 85 by the Mobile Device software application match the credential factors associated with an existing user account within a user database on the web application server 90. If the web application server 90 does not find a match for the submitted credentials factors 85, then the web application server 90 responds 92 to the Mobile Device software application with an appropriate error message. If the web application server 90 finds a user account to match the submitted credentials factors 85, then another validation 93 is performed for the purpose of determining whether the Mobile Device ID 89 is associated with an end user account.

The web application server 90 performs a validation 93 to determine whether a specific Mobile Device ID has already been associated with the end user account. If no such Mobile Device ID is associated with the end user account, the web application server 90 associates 94 the Mobile Device ID 89 as transmitted along with the submitted credential factors 85 to the end user account in the web application server database. Following the association 94, the web application server 90 is able to authenticate 97 the Mobile Device end user submitted factors of username 86 and user password 87, the Personal Authentication Credential Factor 88 and Mobile Device ID 89 and the Mobile Device end user can be allowed appropriate access in order for the Mobile Device software application to begin fulfilling its intended purpose. However, if the web application server 90 verifies that the end user account does have an associated Mobile Device ID, the web application server 90 performs a validation 95 to determine whether or not the Mobile Device ID 89 transmitted along with the submitted credentials 85 matches the Mobile Device ID listed in the web application server database as associated with the Mobile Device end user's user account. If the Mobile Device IDs do not match, the web application server 90 responds to the Mobile Device application with an appropriate error message 96. If the Mobile Device IDs match, then the Mobile Device software application is connected to the databases of the web application server 90 and the Mobile Device end user is able to access the functionality of the Mobile Device software application as intended. The web application server 90 was able to authenticate 97 the Mobile Device end user based submitted factors of username 86 and user password 87, the Personal Authentication Credential Factor 88, and Mobile Device ID 89 and the Mobile Device end user can be allowed appropriate access in order for the Mobile Device software application to begin fulfilling its intended purpose.

The above examples and disclosure are intended to be illustrative and not exhaustive. These examples and description will suggest many variations and alternatives to one of ordinary skill in this art. All of these alternatives and variations are intended to be included within the scope of the claims, where the term “comprising” means “including, but not limited to”. Those familiar with the art may recognize other equivalents to the specific embodiments described herein which equivalents are also intended to be encompassed by the claims. Further, the particular features presented in the dependent claims can be combined with each other in other manners within the scope of the invention such that the invention should be recognized as also specifically directed to other embodiments having any other possible combination of the features of the dependent claims. For instance, for purposes of written description, any dependent claim which follows should be taken as alternatively written in a multiple dependent form from all claims which possess all antecedents referenced in such dependent claim.

1. A method for the secure distribution of a Personal Authentication Credential Factor, for Mobile Devices, comprising the steps of:
an end user requesting a Personal Authentication Credential Factor for installation onto a Mobile Device,
a Security Officer receiving the end user request,
providing the request for a Personal Authentication Credential Factor to an Authority, wherein the Authority is capable of communicating with a Mobile Device,
generation of a security code and Personal Authentication Credential Factor code by the Authority and corresponding to a Personal Authentication Credential Factor file or string, Personal Authentication Credential Factor filename, and Personal Authentication Credential Factor file extension,
providing the security code to the Security Officer for authentication,
the Security Officer communicating the security code to the end user,
providing authentication of the Mobile Device through verification of the security code as provided to the end user,
providing authentication of the Mobile Device through verification of the Personal Authentication Credential Factor code corresponding to the Personal Authentication Credential Factor,
validating the presence of a Personal Authentication Credential Factor on the Mobile Device,
the Authority sending the Personal Authentication Credential Factor to the Mobile Device associated with an authenticated end user presenting a valid request for the Personal Authentication Credential Factor,
storing the Personal Authentication Credential Factor in the Mobile Device's internal memory, and
authenticating the end user upon login from the Mobile Device to a Mobile Device software application based on multiple factors.

2. The method of claim 1 wherein the Personal Authentication Credential Factor code and/or security code may be hashed one or multiple times.

3. The method of claim 2 wherein the Mobile Device software application and Authority utilize the same hash method.

4. The method of claim 3 wherein validation of the Mobile device is performed through comparison of hashed values of the security code and Personal Authentication Credential Factor code on a Mobile device to hashed values of the security code and Personal Authentication Credential Factor code within an Authority database.

5. The method of claim 1 wherein the Personal Authentication Credential Factor is converted to a mobile operating system Personal Authentication Credential Factor file format.

6. The method of claim 1 wherein the Personal Authentication Credential Factor is encoded by the Authority.

7. The method of claim 6 wherein the Mobile Device software application is capable of decoding the Personal Authentication Credential Factor.

8. The method of claim 1 wherein the Personal Authentication Credential Factor is associated with a password.

9. The method of claim 8 wherein further authentication of the Mobile Device is made through verification of the password corresponding to the Personal Authentication Credential Factor

10. The method of claim 1 wherein the authentication of end user upon login from the Mobile Device to an application is based on four factors: username, password, Personal Authentication Credential Factor, and Mobile Device ID

11. The method of claim 10 wherein the Personal Authentication Credential Factor is a digital certificate.

12. The method of claim 11 wherein the digital certificate is based on public key infrastructure.

13. The method of claim 10 wherein the Personal Authentication Credential Factor is a biometric authentication system.

14. The method of claim 10 wherein the Personal Authentication Credential Factor is a location based authentication system.

15. The method of claim 10 wherein the Personal Authentication Credential Factor is a token-based authentication system.

16. The method of claim 10 wherein the Personal Authentication Credential Factor is any authentication system capable of generating a Personal Authentication Credential Factor.

17. The method of claim 1 further including the method for establishing the authenticity of the Mobile Device end user's attempt to log in and utilize Mobile Device software applications from the Mobile Device by:
authenticating the end user based on the username factor,
authenticating the end user based on the password factor,
authenticating the end user based on the Personal Authentication Credential Factor, and
authenticating the end user based on the Mobile Device ID factor.

18. The method of claim 17 wherein the Personal Authentication Credential Factor is a digital certificate.

19. The method of claim 18 wherein the digital certificate is based on public key infrastructure.

20. The method of claim 17 wherein the Personal Authentication Credential Factor is a biometric authentication system.

21. The method of claim 17 wherein the Personal Authentication Credential Factor is a location based authentication system.

22. The method of claim 17 wherein the Personal Authentication Credential Factor is a token-based authentication system.

23. The method of claim 17 wherein the Personal Authentication Credential Factor is any authentication system capable of generating a Personal Authentication Credential Factor.

24. A system for the secure distribution of a Personal Authentication Credential Factor, for Mobile Devices, comprising:
an Authority or other such authentication server,
a Mobile Device in communication with the Authority or other such authentication server, the Mobile Device having a processor, an operating system and an internal memory,
the system configured to:
provide authentication of the Mobile Device through verification of the Personal Authentication Credential Factor,
validate the presence of a Personal Authentication Credential Factor on the Mobile Device,
send the Personal Authentication Credential Factor to the Mobile Device associated with an authenticated end user presenting a valid request for the Personal Authentication Credential Factor,
store the Personal Authentication Credential Factor in the Mobile Device's internal memory, and
authenticate the end user upon login from the Mobile Device to an application based on multiple factors.

25. The system of claim 24 wherein the authentication of end user upon login from the Mobile Device to an application is based on four factors: username, password, Personal Authentication Credential Factor, and Mobile Device ID.

26. The system of claim 24 wherein the Personal Authentication Credential Factor code and/or security code may be hashed one or multiple times.

27. The system of claim 26 wherein the Mobile Device software application and Authority utilize the same hash method.

28. The system of claim 27 wherein validation of the Mobile device is performed through comparison of hashed values of the security code and Personal Authentication Credential Factor code on a Mobile device to hashed values of the security code and Personal Authentication Credential Factor code within an Authority database.

29. The system of claim 24 wherein the Personal Authentication Credential Factor is converted to a mobile operating system Personal Authentication Credential Factor file format.

30. The system of claim 24 wherein the Personal Authentication Credential Factor is encoded by the Authority.

31. The system of claim 30 wherein the Mobile Device software application is capable of decoding the Personal Authentication Credential Factor.

32. The system of claim 24 wherein the Personal Authentication Credential Factor is associated with a password.

33. The system of claim 32 wherein further authentication of the Mobile Device is made through verification of the password corresponding to the Personal Authentication Credential Factor.

34. The system of claim 25 wherein the Personal Authentication Credential Factor is a digital certificate.

35. The system of claim 34 wherein the digital certificate is based on public key infrastructure.

36. The system of claim 25 wherein the Personal Authentication Credential Factor is a biometric authentication system.

37. The system of claim 25 wherein the Personal Authentication Credential Factor is a location based authentication system.

38. The system of claim 25 wherein the Personal Authentication Credential Factor is a token-based authentication system.

39. The system of claim 25 wherein the Personal Authentication Credential Factor is any authentication system capable of generating a Personal Authentication Credential Factor.

40. The system of claim 24 further including the method for establishing the authenticity of the Mobile Device end user's attempt to log in and utilize Mobile Device software applications from the Mobile Device by:
authenticating the end user based on the username factor,
authenticating the end user based on the password factor,
authenticating the end user based on the Personal Authentication Credential Factor, and
authenticating the end user based on the Mobile Device ID factor.

41. The system of claim 40 wherein the Personal Authentication Credential Factor is a digital certificate.

42. The system of claim 41 wherein the digital certificate is based on public key infrastructure.

43. The system of claim 40 wherein the Personal Authentication Credential Factor is a biometric authentication system.

44. The system of claim 40 wherein the Personal Authentication Credential Factor is a location based authentication system.

45. The system of claim 40 wherein the Personal Authentication Credential Factor is a token-based authentication system.

46. The system of claim 40 wherein the Personal Authentication Credential Factor is any authentication system capable of generating a Personal Authentication Credential Factor.
